(19) United States
(12) Patent Application Publication
(10) Pub. No.: US 2023/0138539 A1
(43) Pub. Date: May 4, 2023

(54) Brake pad assembly with lining carrier that has an internal axial elasticity

(71) Applicant: HL MANDO CORPORATION, Pyeongtaek-si (KR)

(72) Inventors: Hatem SHAHIN, Pfaffenhofen (DE); Volker KINDER, Russelsheim (DE)

(73) Assignee: HL MANDO CORPORATION, Pyeongtaek-si (KR)

(21) Appl. No.: 17/978,388

(22) Filed: Nov. 1, 2022

(30) Foreign Application Priority Data
Nov. 1, 2021 (DE) 102021212291.4

(51) Int. Cl. F16D 65/092

(52) U.S. Cl. CPC F16D 65/092

(57) ABSTRACT

The invention relates to a brake pad assembly (10) for a vehicle disc brake (11), the brake pad assembly (10) comprising a lining carrier (12) and a brake lining layer (14) attached to the lining carrier (12), wherein the lining carrier (12) has a first portion and a second portion which are connected by at least one connecting portion (20) forming at least part of a side face (21) of the lining carrier (12), wherein the connecting portion (20) is elastically deformable upon braking.

The invention relates to a brake pad assembly for a vehicle disc brake.

Brake pads for vehicle disc brakes typically comprise a lining carrier (also referred to as backing plate or back plate, the terms being used interchangeably in this disclosure). To said lining carrier a brake lining layer is attached. The brake pad is axially displaceable upon braking in order to generate a contact between the brake lining layer and a brake disc. This results in frictional forces providing the desired braking effect.

Once the brake is released, the brake lining layer should be lifted off the brake disc to avoid an undesired generation of drag. This is often referred to as a restoring or resetting of the brake pad and as avoiding drag torque.

A number of technologies exist for ensuring a respective restoring effect. For example, springs may be connected to the brake pad and are elastically deformed upon braking. When releasing the brake, the springs provide a restoring force that displaces the brake pad into its original position, thereby lifting the brake lining layer off the brake disc.

Further, elastically deformable sealing elements that deform in accordance with a movement of a brake piston are known. When releasing a brake pressure acting on the piston, these sealing elements return to their original shape. By doing so, they exert displacement forces onto the piston and the brake pad which return them into their original positions.

While such solutions may provide the desired resetting function to some degree, there is still room for improvement. For example, the lifetime within which the resetting function can reliably be provided should be increased. Further, a reliable formation of a uniform gap between the brake lining layer and brake disc over the complete contact surface of said brake lining layer should be ensured.

The present solution solves these issues by providing a brake pad assembly as defined in the attached claim 1. Advantageous embodiments are defined in this description and in the dependent claims.

Accordingly, a brake pad assembly for a vehicle disc brake is disclosed, the vehicle e.g. being a car or a truck.

The brake pad assembly comprises a lining carrier (differently put, a backing plate) and a brake lining layer e.g. comprising a friction material. The brake lining layer is attached to the lining carrier.

The lining carrier has a first portion and a second portion. The first and second portion may also be referred to as first and second part. The first and second portion are connected to one another by at least one connecting portion. The connecting portion forms at least part of a side face of the lining carrier. The connecting portion is elastically deformable upon braking.

Braking preferably comprises moving the brake pad so as to bring it (and in particular a contact surface of its brake lining layer) into contact with a brake disc of the vehicle disk brake.

The brake pad assembly thus comprises a lining carrier that is elastically deformable by way of its connecting portion. This means that no other or at most less comprehensive measures need to be taken to achieve elastic characteristics by means of which the above discussed restoring or resetting function can be achieved.

Differently put, an elastic behavior is directly integrated into the brake pad and specifically its lining carrier. This represents an alternative to providing separate springs that are e.g. attached to the lining carrier or to providing sealing elements that interact with a brake piston in the above-described manner. Nonetheless, the present solution may also be provided in addition to such sealing elements, springs or any other existing restoring or resetting means.

The presently disclosed elastically deformable brake lining carrier is further advantageous in that it can reliably establish a desired gap between the brake lining layer and brake disc over a large portion and preferably over the complete contact surface of the brake lining layer. For example, it can particularly reliably establish a uniform gap and/or a gap that exceeds a minimum acceptable value. Typical desired gap sizes range from 0.1 to 1 mm.

The lining carrier may be flat with a substantially rectangular, polygonal or oval outline. Its first and second portion may be integrally connected. Put differently, the first and second portion may be comprised by a one-piece member. In this context, the connecting portion may be a portion of said one-piece member that is e.g. shaped to provide the elastic deformability. For example, the connecting portion may comprise at least one section that is integrally connected to each of the first and second lining carrier portion, said section e.g. being bendable, compressible or tiltable to provide the elastic deformation.

According to preferred embodiments, the lining carrier can also have a multi-part or multi-member design with the first and second potion being comprised by different parts/members. These are connected to one another by, at and/or within the connecting portion, e.g. permanently by welding or gluing, and/or by means of mechanical engagements or form fits.

In one example, the connecting portion has a U- or V-shaped cross-section and a distance of the opposite legs of said U- or V-shape may be varied during the elastic deformation.

At least part of the first and second portion may be flat and/or plate-shaped. These flat parts may extend in parallel to one another as well as to (e.g. a center plane, rear face or contact surface) of the brake lining layer. Starting from the contact surface of the brake lining layer and viewed along a displacement axis of the brake pad assembly (that e.g. extends orthogonally to the contact surface), the contact surface, first portion and second portion may follow each other.

The first portion of the lining carrier may comprise at least one surface to which the brake lining layer is attached (e.g. with a rear face thereof). The second portion of the lining carrier may comprise at least one surface against which a brake piston of the vehicle disc brake may rest and/or to which said brake piston is connected or connectable. Put differently, said surface may be configured (e.g. oriented and sized) to contact and/or receive displacement forces generated by the brake piston.

In a generally known manner, the brake pad assembly may be displaceable received in e.g. a brake caliper of the vehicle disc brake. Upon braking and receiving forces from the brake piston, the brake pad assembly may be linearly displaced to contact the brake disc.

The connecting portion may be the only elastically deformable portion of the braked pad assembly when braking or may at least experience the largest elastic deformation upon braking. This way, the elastic behavior can reliably be set.

The side faces of the lining carrier may also be referred to as edges. They may form an outline of the lining carrier. They may extend circumferentially and/or around the displacement axis. In one example, at least one of the side faces and in particular the connecting portion comprised thereby may be non-flat, but e.g. dented, kinked or angularly shaped. Thereby, an elastic behavior of the connecting portion may be provided.

Preferably, there are at least four side faces. For example, when facing the brake lining layer and/or with respect to a radial direction an upper, lower, left and right side face can be provided. Note that radial axes and directions are generally defined herein with respect to a rotational axis of the brake disc and/or a displacement or deformation axis of the braked pad assembly. A radial direction extends at angle and in particular orthogonally to these axes, whereas axial directions may extend in parallel thereto.

By forming part of at least one of the side faces, the connecting portion may extend along and/or form at least part of an outer rim or edge of the lining carrier. Due to its elastic deformability, said edge may be axially compressible. In general, as a result of the elastic deformation, an axial distance between the first and second portion may be reduced. Said distance may be increased and may return to its original state when the brake is released.

Providing the elastic connecting portion at or within a side face enables a compact (e.g. flat) design of the brake pad assembly while reliable providing an elastic behavior. Also, it makes use of a section of the brake pad that may otherwise provide no distinctive function, e.g. that does not connect to a brake piston or carries the brake lining layer. Thus, modifications compared to existing lining carrier designs can be limited and may e.g. concentrate on the side faces. Also, this helps to maintain compactness.

Generally, the present solution can also help to reduce part numbers because no or at most less additional springs may have to be provided and connected to the lining carrier during assembly to provide a desired elastic characteristic.

In one example, the elastic deformation (of the connecting portion) includes compressing the connecting portion along a deformation axis which is orthogonal to said contact surface. In other words, the elastic deformation may include an axial compression and, when removing the deforming force, a corresponding axial relaxation and extension. The latter may provide or result from a resetting force that is oriented oppositely to the brake pad displacement upon braking. Generally, the deformation axis may coincide with a displacement axis of the brake pad assembly.

According to a further aspect, the connecting portion is configured to upon releasing the vehicle disc brake move (in particular by way of an elastic restoring force) the contact surface towards a position before braking and/or away from the brake disc, preferably while establishing a gap thereto.

Put differently, the contact surface can be reset, moved back, displaced or returned towards a position before braking upon releasing the vehicle disc brake. This may be the result of the initially elastically deformed connecting portion relaxing and returning to its non-deformed initial shape. By releasing the brake, a previous force exerted onto the connecting portion is removed and an elastic restoring force is instead provided by the connecting portion. Said force may push the brake lining layer against and thus off the brake disc.

Note that other retraction forces moving the contact surface away from the brake disc may additionally be provided, e.g. by a retracting brake piston and/or by a sealing element acting on said brake piston.

In one example, the connecting portion has at least one section extending at an angle to the deformation axis. The angle may be variable as a result of said elastic deformation, e.g. due to said section being bent and/or tilted. This enables a simple and axially compact design.

According to a preferred embodiment, the connecting portion forms at least half the length of the side face. The length may refer to an extension in a circumferential direction and/or orthogonally to a displacement axis or deformation axis disclosed herein. By providing a respectively elongated connecting portion, the elastic behavior and in particular the preferred restoring function can be provided with respect to large portion of the brake pad assembly. This means that the desired gap between the brake lining layer and brake disc can be established in a respectively large region and preferably over the complete contact surface of the brake lining layer.

Generally the connecting portion may have an elongated and/or narrow shape. It may be continuous. It may extend at angle to the displacement axis and/or deformation axis. It may have a length of at least 5 cm, preferably more than 10 cm. A width dimension, which may be the axially compressive dimension, may be smaller than said length. It may amount to not more than half or more than a quarter of said length.

In one example, the brake lining layer has a width and a height dimension that e.g. extend orthogonally to one another and/or to a displacement or deformation axis disclosed herein. The height dimension may extend radially. The width dimension may extend in between guiding projections discussed below. The connecting portion may extend along at least half the length of one of the width or height dimension (e.g. depending on the orientation of the side face formed by the connecting portion).

According to one example, at least two connecting portions are provided at different side faces. In particular, the connecting portions may at least partially form different side faces of the lining carrier, e.g. a first connecting portion may form at least part of a first side face and a second connecting portion may from at least part of a second (different) side face. The side faces may be opposite to one another, e.g. may be a top and bottom or left and right side face.

By providing elastic connecting portions at different side faces, uniformity of the restored gap between the brake lining layer and brake disc can be improved. Also, tilting and/or vibrations of the brake lining layer can be limited. Further, the desired elastic behavior and/or reduction of axial stiffness can be distributed over an increased number of connecting portions and/or side faces. This enables still maintaining an axially limited thickness and overall flat shape of the lining carrier.

It may be provided that the connecting portion extends circumferentially. This way, it may form part of different and in particular of all side faces of the lining carrier. The connecting portion may have a largely or substantially fully closed or continuous configuration when extending circumferentially, e.g. to provide a closed circumferential surface comprising the different side faces. Nonetheless, it may include local cut-outs (e.g. at at least one corner portion) to simplify manufacture.

For providing a desired elastic behavior, the connecting portion may be uniformly configured or its characteristics may be varied, e.g. along the circumference. When a plurality of connecting portions is provided, said connecting portions may be similarly configured or may differ from one another. In this context, relevant parameters of the connecting portion determining a uniform or different configuration, may e.g. be any of geometric dimensions of any portion or section (e.g. length or width (i.e., axial dimension), material selection, (axial) spring rate or the angle of any angled portion or angled section that may change its orientation as a result of an elastic deformation.

Preferably, the connecting portion has a linear deformation characteristic, e.g. with respect to an expected range of forces applied during braking. That is, the connecting portion is preferably not plastically deformable with respect to said expected range of forces. This ensures that the restoring function and the thereby generated preferably uniform gap can be provided over a long lifetime of the brake pad assembly, while also providing a constant brake pedal feel. Put differently, the spring characteristic of the connecting portion may be linear even at increasing brake lining wear and/or over the whole lifetime of the brake pad assembly.

In case a non-linear displacement characteristic of the brake pad assembly is preferred, e.g. to compensate for wear of the brake lining layer and thus increasing brake pedal travel, such a non-linearity is preferably provided independently of the connecting portion. Instead, known brake lining wear compensation means may be used. These may include a permanent displacement of the brake pad assembly towards the brake disc by means of a parking brake actuator or by sealing elements allowing for a permanent relative displacement of the brake piston at increasing brake piston travel.

The connecting portion, however, preferably shows the same elastic deformation behavior regardless of wear.

This helps to provide a constant brake pedal feel form the driver's perspective even at increasing brake lining wear. This is because contrary to many known restoring springs having nonlinear deformation characteristics and e.g. plastically deforming to compensate brake lining wear, the connecting portion may be non-plastically deformable and thus maintain a constant linear spring characteristic.

Presently, using a linear elastic characteristic is made possible by integrating the axial elastic behavior (and in particular axial resetting function) into the movable lining carrier. The provided spring in form of the connecting portion is not fixed to non-movable components or components relative to which the braked pad axially moves, such as the brake caliper or brake carrier. So far, at increasing brake lining wear, relative distances and/or movements of the brake pad relative to said components typically need to be adjusted. This often requires permanently and/or nonlinearly deforming springs attached to these components as well (e.g. connecting said components and the brake pad). Presently, however, the lining carrier can e.g. be permanently displaced as a whole to compensate for brake lining wear (e.g. by known seal and guide pin interactions at the brake caliper). This way, it can maintain its unchanged and constant elastic characteristics, or put differently, maintain its axially linear spring characteristics. This results in a constant brake pedal feel during braking over the whole lifetime of the brake pad assembly.

Therefore, according a preferred embodiment, the brake pad assembly is free of (e.g. not supported by, not resting against, not connected to and/or not in contact with) any springs that rest against or that are fixed to other components of the overall wheel brake assembly, such as a brake carrier. As noted above, this may especially apply to components relative to which the brake pad assembly axially moves during braking. Instead, the connecting portion may be the only or at least the dominant axial spring element that provides an axial force for resetting the brake pad.

The first and second portion may enclose a space in between them. This space may be flat and extend orthogonally to the displacement axis and/or deformation axis. It may be confined by any of the side faces of the lining carrier. It may be confined by inner faces of the first and second portion that face each other. The space may at least partially be empty, thus providing a partially hollow and thus lightweight lining carrier. Also, the space may at least partially be filled. The material used for filling said space may provide a noise and/or vibration damping effect. It may e.g. be a foam, a heat-resistant plastic material or a glass-fiber reinforced material. This way, the lining carrier can have preferred acoustic or mechanical characteristics while still having a limited weight.

According to a further embodiment, the lining carrier comprises at least a first member comprising the first portion and a second member comprising the first portion, the first and second member being connected to one another within the connecting portion. The first and second member may also be referred to as first and second components. They may be separately produced and e.g. mechanically connected or substance-bonded by welding, gluing or soldering.

Connecting such initially separate members may limit production costs. Connecting them by or within the connecting portion increases functional integration, e.g. due to the formed connection preferably directly contributing to the elastic behavior.

In one example, the first member and the second member engage each other in the connecting region. For example, they may at least partially be inserted into or locked to one another. By way of said engagement, the first and second member may be (e.g. axially) locked to one another. As a result of the elastic connecting portion, they may nevertheless be axially movable relative to one another, while remaining engaged and connected.

In one example, the first and second member may each have portions and/or surfaces for providing the functions of the first and second portions discussed above (i.e. connecting to the brake lining layer and connecting to a brake piston, respectively). At said surfaces, angled sections (also referred to as connecting sections herein) may be provided to produce a mechanical engagement between the members. This represents a simple design that is easy to produce.

According to a preferred embodiment, at least one of the first member and the second member are formed from sheet metal and preferably is sheet metal bending part. This enables a cheap and light design. In this context, angled sections to form above-discussed connection and in particular engagement between the members can be directly bent as needed during production.

Note that the two members may also be connected to one another via vibration dampening features, such as elastic dampers included in at least part of the connecting portion. This may help to reduce vibrations, thereby e.g. limiting the emission of squeal noises or other brake noises.

Further, the members may be configured similar or different from one another in terms of material. Generally, the material comprised by and/or forming the connecting portion may be different from other materials comprised by the lining carrier, and e.g. used for forming a portion of the lining carrier that contacts the brake piston or the brake lining. Accordingly, any of the first and second member may be made from a uniform material and/or may be configured as a one-piece member, or may comprise different materials.

In a further example, the lining carrier comprises guiding projections for being received in a brake caliper of the vehicle disc brake. Such guiding projections are also referred to as hammer heads in the technical field. They are typically provided at opposite sides of the lining carrier (e.g. a left and right side) and are slidingly received in the brake carrier. The guiding projections may help to center the brake pad within the vehicle disc brake and e.g. limit undesired tilting movements thereof.

In the context of this disclosure, the guiding projections are preferably arranged at a common portion and further preferably at the second portion of the brake carrier. This can improve stiffness of the guiding projections relative to one which limits vibrations. For example, by being placed at a common one of the first and second portion, forces can flow directly between the guiding portions without a large share thereof passing through the elastic connecting portion.

In order to provide a reliable brake pad resetting effect, an elastic restoring force of the deformed connecting portion (that is set free when releasing the brake) preferably exceeds frictional forces between the guiding projections and the brake caliper. This way, it is ensured that the elastic restoring force is sufficient for displacing the brake pad in an opposite direction in order to provide the desired gap or clearance to the brake disc.

Embodiments of the invention are described in further detail below with respect to the attached schematic figures. Same features may be marked with the same reference signs throughout the figures.

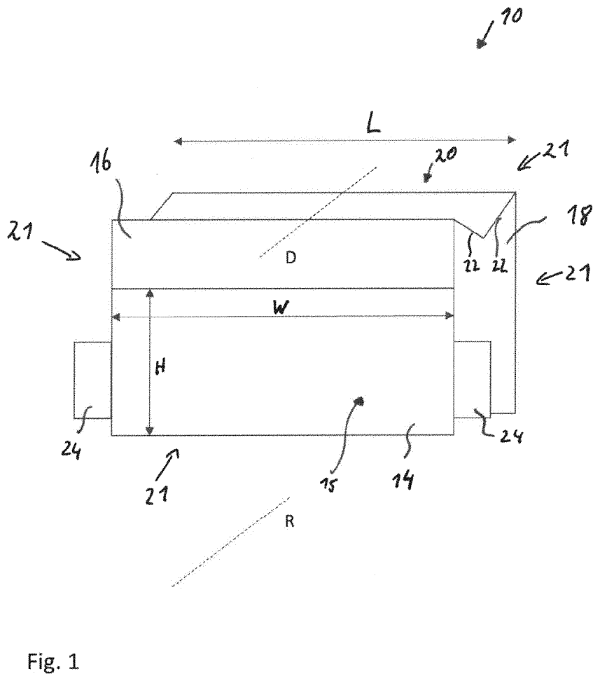

FIG. 1 is a perspective view of a brake pad assembly according to first embodiment of the invention.

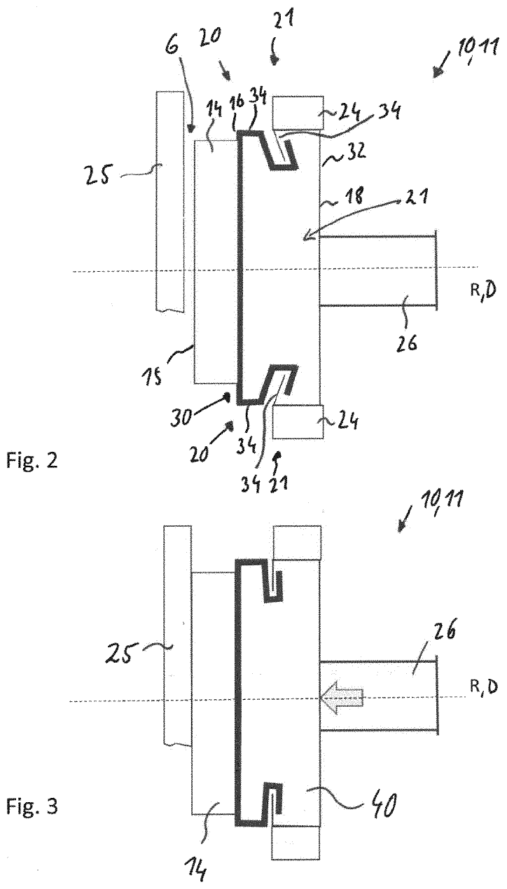

FIG. 2 is a partial top view of a brake pad assembly according to second embodiment of the invention with the brake being released.

FIG. 3 is a view similar to FIG. 2 with the brake being activated.

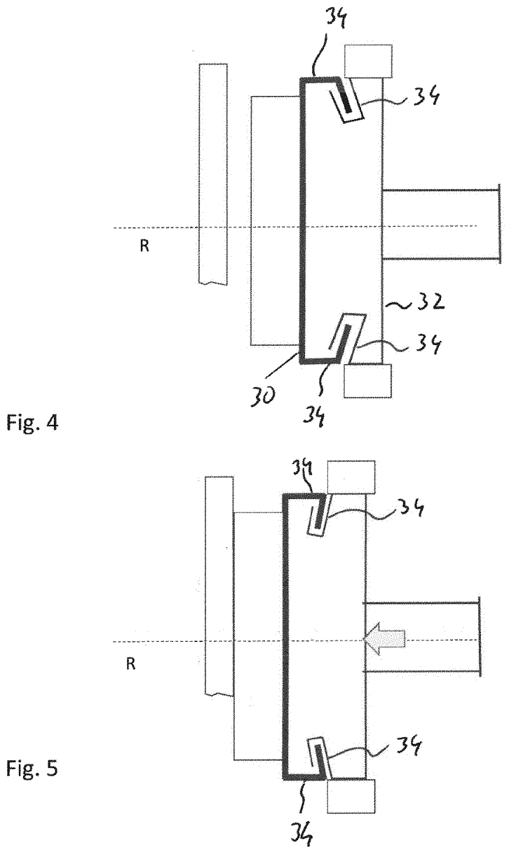

FIG. 4 is a partial top view of a brake pad assembly according to third embodiment of the invention with the brake being released.

FIG. 5 is a view similar to FIG. 4 with the brake being activated.

FIG. 1 is a perspective view of a brake pad assembly 10 according to a first embodiment. The illustration is highly schematic and the depicted shapes and sizes are merely exemplary. The brake pad assembly 10 is configured to be mounted to a vehicle disc brake 11 that is not specifically illustrated and that is configured according to known solutions. Selected components of the vehicle brake assembly 11 are shown in FIGS. 2-5 (see brake disc 25 and brake piston 26).

The brake pad assembly 10 comprises a lining carrier 12 that can also be referred to as a backplate. At a front face of the lining carrier 12 which faces the viewer, a brake lining layer 14 is arranged. By way of example, the brake lining layer 14 has a rectangular shape. Its front face facing the viewer is a contact surface 15 which can be brought into contact with a non-depicted brake disc of the vehicle disc brake 11.

For doing so, the brake pad assembly 10 is axially displaceable along and in parallel to an axis R. This axis R is a rotational axis about which the brake disc rotates. When releasing the brake, the brake pad assembly 10 is displaced in an opposite direction along the axis R in order to lift the brake lining layer 14 off the brake disc. This is discussed in further detail with respect to the subsequent FIGS. 2-5.

In FIG. 1, as a mere simplification, a thickness of the brake lining layer 14 along the axis R is not specifically illustrated.

The lining carrier 12 comprises two portions 16, 18. These extends in parallel to one another as well as in parallel to the brake lining layer 14. More precisely, each of the first portion 16 and second portion 18 are substantially flat and/or plate-shaped. Their respective planes extend substantially in parallel to the brake lining layer 14 (in particular to a rear surface thereof that is attached to the lining carrier 12).

The second portion 18 (and more precisely a rear surface thereof facing away from the viewer) contacts a non-illustrated brake piston (see also following FIGS. 2-5). In a generally known manner, the brake piston can exert a brake force onto said rear surface, thereby pushing the brake pad assembly 10 along the axis R and bringing the contact surface 15 of the brake lining layer 14 into contact with the brake disc. When releasing the brake, the brake piston ceases to exert respective forces and an elastic restoring force discussed below pushes the brake pad assembly 10 back into its original position.

The first and second portion 16, 18 are connected to one another by a connecting portion 20. Said connecting portion 20 forms an (in FIG. 1) radially upper side face 21 of the lining carrier 12. Preferably, more than one side face 21 of the lining carrier 12 comprises or is at least partially formed by a similar connecting portion 20 (not shown). For example, at least the opposite radially lower side face 21 is likewise formed by a similarly configured connecting portion 20. The brake pad assembly 20 also has two further side faces 21, namely a left and right one in FIG. 1, that connect said radially upper and lower side face.

If all side faces are formed by a respective connecting portion 20, a continuous circumferentially extending connecting portion may be provided. Yet, at least corner portions at which two side faces 21 merge or are directly adjacent to one another may be free of a respective connecting portion 20.

The connecting portion 20 (and any further non-depicted connecting portion 20) is an elastically deformable portion of the lining carrier 12 that provides a dedicated reduced axial stiffness of the brake pad assembly 10. Specifically, the lining carrier 12 is elastically and axially compressible by deforming said connecting portion 20, thereby altering an axial distance between the first and second portion 16, 18.

Merely as an example, the connecting portion 20 is formed as an elongated and inwardly bent or inwardly kinked portion. It has a V-shaped cross-section comprising two angled sections 22 each forming a leg of said V-shape. Each angled section connects to one of the first and second portion 16, 18 and connects to the respective other angled section. The angled sections 22 may also be referred to as planar or elongated flaps. They extend at an angle to the axis R.

When pushing the brake pad assembly 20 against the brake disc, an axial compression force acts on the connecting portion 20. The connecting portion 20 is elastically deformed by said force. Specifically, its angled portions 22 will change their orientation and e.g. assume a more upright orientation relative to the axis R. As a result, an axial distance between the first and second portion 16, 18 is reduced and the connecting portion 20 is generally axially compressed. This compression takes place along a deformation axis D that extends in parallel to the rotational axis R.

When releasing the displacing force, the connecting portion 20 elastically relaxes and, by way of an elastic resetting force, returns to its original shape. That is, the angled sections 22 return to their less upright orientation depicted in FIG. 1 while increasing the axial distance between the first and second portion 16, 18.

As further evident from FIGS. 2-5, this also means that the contact surface 15 of the brake lining layer 14 pushes off the brake disc due to the stored elastic deformation energy being released. Thus, the desired clearance between the brake lining layer 14 and brake disc is established.

The depicted connecting portion 20 has a substantial length L of several centimeters. Said length L is measured in a plane that is orthogonal to the axis R. Due to said large length L, the elastic resetting forces can be exerted along the complete brake lining layer 14 to increase uniformity of the established clearance.

Specifically, the brake lining layer 14 and in particular its contact surface 15 has a width dimension W and a height dimension H extending orthogonally to one another. The height dimension H extends substantially radially, e.g. defining a distance between a radially upper and radially lower of the brake lining layer 14. The width dimension W defines a distance between a left and right edge of the brake lining layer 14. The width dimension W also extends in between two guiding projections 24 that are configured as generally known hammer-head projections.

In the shown example, the length L of the connecting portion 20 is substantially the same as the width dimension W. Generally, it preferably amounts to at least half of said width W. In case similar connecting portions 20 are provided at the right and/or left side faces 21, their length L (which is oriented similar to the height dimension H) preferably amounts to at least half of said height H.

The depicted embodiment advantageously integrates an elastic resetting function directly into the lining carrier 12 by way of the at least one elastically deformable connecting portion 20.

FIG. 2 depicts a top view of a brake pad assembly 10 according to a second embodiment. As evident form the orientation of the axis R (which again is a rotational axis of a brake disc 25), a viewing axis thus extends radially and a radially upper side face 21 faces the viewer. The displacement axis D is thus overlaid with the rotational axis R.

Only by way of example, no connecting portion 20 is provided at said upper side face 21, but there may be a connecting portion that is e.g. configured according to FIG. 1 or that is similar to the connecting portions 20 of this second embodiment (see below).

Again, the left and right guiding portions 24 are shown. Also, a brake piston 26 is depicted that is connected to (e.g. mechanically fixed to) a rear surface of the brake lining carrier 12.

In this second embodiment, the brake lining carrier 12 is configured as a multi-part unit. Specifically, the first portion 16 at which the brake lining layer 14 is arranged is comprised by a first member 30. The second portion 18 that contacts the brake piston 26 is comprised by a second member 32.

For the purpose of illustration only, the first and second member 30, 32 are illustrated with different line widths. These line widths are not meant to indicate a material thickness of the respective members 30, 32. Said members 30, 32 can be provided with similar material thicknesses. Also, the second member 32 can be made form a thicker sheet metal than the member 30, and vice versa.

Each of the first and second member 30, 32 are configured as sheet metal bending parts. From their respectively planar first a second portions 16, 18, connecting sections 34 are angled so as to protrude towards the respective other one of the first or second member 30, 32.

Merely as an example, these connecting sections 34 are only provided at left and right outer edges of the members 30, 32. They can also be provided, additionally or alternatively, at their radially upper and lower edges.

The exact shape and dimensions of the connecting sections 34 can differ from the schematically depicted example. In the shown example, the connecting section 34 of the first member 30 forms a receiving portion, whereas the connecting section 34 of the second member 32 forms a projecting portion that is inserted into said receiving portion. This way, the connections sections 34 and thus the members 30, 32 can be brought into engagement with one another.

In addition or alternatively to said engagement or form-fit, a more permanent connection by way of gluing or welding can be provided.

Again, the connection between the first and second portion 16, 18 and more specifically between the members 30, 32 comprising said portions 16, 18 is made at or within a side face 21 of the lining carrier 12. That is, the above-discussed connection between the connecting sections 34 forms left and right connecting portions 20 that represent left and right side faces 21 of the lining carrier 12.

Each connecting portion 20 extends orthogonally to the image plane and thus along the height dimension H of the brake lining layer 14 (see FIG. 1). Again, a length of each connecting portion 20 may be equivalent to or amount to at least half of said height dimension.

Further, by extending orthogonally to the image plane, it is evident that the connecting sections 34 each have an elongated flap shape.

In FIG. 2, the brake is not activated and the brake piston 26 does not exert an axial force onto the brake pad assembly 10. Therefore, the brake lining layer 14 remains at a distance from the brake disc 25 so that no brake effect is produced. A respective clearance or gap is marked by the reference sign G in FIG. 2.

Further, the connecting portions 20 are each undeformed. Their connecting sections 34 extend at angles to the axis R and assume orientations given to them during initial production and when not under load.

FIG. 3 shows the piston 26 exerting a braking force onto the rear surface of the second member 32 (see arrow in FIG. 3). The brake assembly 10 is thus moved along the axis R and the brake lining layer 14 is forced into contact with the brake disc 25 to generate frictional braking forces.

As a result, the connecting portions 20 are elastically deformed. Specifically, they are axially compressed so that a distance between the parallel front and rear surfaces of the first and second member 30, 32 is slightly reduced. Further, their connecting sections 34 are at least partially deformed by being elastically bent. This results in a change of orientation e.g. with respect to the axis R. For example, it can be seen that the connecting sections 34 become more upright with respect to said axis R.

When releasing the brake, hydraulic pressure is released from the brake piston 26 which thus ceases to exert the pushing force onto the brake pad assembly 10. This means that the stored elastic deformation energy is set free. More precisely, an axial elastic restoring force of the bent connecting sections 34 pushes the brake pad assembly 10 off and away from the axially stationary brake disc 25. In order to be able to so, the connecting sections 34 are e.g. sized, orientated and made from a suitable material, so that the elastic restoring forces exceed a frictional resistance between the guiding projections 24 and the non-depicted brake caliper.

The brake pad assembly 10 is thus axially displaced to return to its original position of FIG. 2. The gap G is restored. The connecting sections 34 return to their original undeformed orientation.

FIGS. 2 and 3 also show that the guiding projections 24 are arranged at a common one of the first and second member 30, 32 (in the shown example at the second member 32).

Further, it is evident that the lining carrier 12 encloses an internal hollow space 40. As previously discusses, a noise dampening material may be arranged in said space 40.

FIGS. 4 and 5 show an embodiment that is largely similar to that of FIGS. 2 and 3. The only difference is the configuration of the connecting sections 34. Compared to the second embodiment, their positioning is reversed in that now the second member 32 has the connecting sections 34 forming a receiving portion. Further, the first member 30 now has the connecting section 34 inserted into said receiving portion. The general operation of the brake pad assembly 10 and its elastic restoring effect is similar to that of the second embodiment.

### LIST OF REFERENCE SIGNS

10 brake pad assembly
11 vehicle disc brake
12 lining carrier
14 brake lining layer
15 contact surface
16 first portion
18 second portion
20 connecting portion
21 side face
22 angled section 8 of connecting portion)
24 guiding projection
25 brake disc
26 brake piston
30 first member
32 second member
34 connecting section
40 space
L length
H height
W width
R rotation axis
D deformation axis

1. A brake pad assembly (10) for a vehicle disc brake (11),
the brake pad assembly (10) comprising a lining carrier (12) and a brake lining layer (14) attached to the lining carrier (12),
wherein the lining carrier (12) has a first portion (16) and a second portion (18) which are connected by at least one connecting portion (20) forming at least part of a side face (21) of the lining carrier (12),
wherein the connecting portion (20) is elastically deformable upon braking.

2. The brake pad assembly (10) according to claim 1,
wherein the elastic deformation includes compressing the connecting portion (20) along a deformation axis (D) which is orthogonal to a contact surface (15) of brake lining layer (14) for contacting a brake disc (25).

3. The brake pad assembly (10) according to claim 2,
wherein said connecting portion (20) has at least one section (22) extending at an angle to said deformation axis (D), said angle being variable when elastically deforming the connecting portion (20).

4. The brake pad assembly (10) according to claim 2,
wherein said connecting portion (20) is configured to move the contact surface (15) towards a position before braking upon releasing the vehicle disc brake (11).

5. The brake pad assembly (10) according to claim 1,
wherein the connecting portion (20) forms at least half of a length (L) of the side face (21).

6. The brake pad assembly (10) according to claim 1,
wherein at least two connecting portions (20) are provided and at least partially form different side faces (21) of the lining carrier (12).

7. The brake pad assembly (10) according to claim 1,
wherein at least the connecting portion (20) extends circumferentially, thereby forming part of different and in particular of all side faces (21) of the lining carrier (12).

8. The brake pad assembly (10) according to claim 1,
wherein the connecting portion (20) has a linear deformation characteristic with respect to an expected spectrum of forces applied during braking.

9. The brake pad assembly (10) according to claim 1,
wherein the lining carrier (12) comprises at least a first member (30) comprising the first portion (12) and a second member (32) comprising the second portion (18), the first and second member (30, 32) being connected to one another within the connecting portion (20).

10. The brake pad assembly (10) according to claim 9,
wherein the first member (30) and the second member (32) engage each other in the connecting portion (20).

11. The brake pad assembly (10) according to claim 9,
wherein the first member (30) and the second member (32) are each formed as a sheet metal bending part.

12. The brake pad assembly (10) according to claim 1,
wherein the lining carrier (12) comprises guiding projections (24) for being received in a brake caliper of the vehicle disc brake (11), the guiding projections (24) being arranged at the second portion (18).
